(19) United States
(12) Patent Application Publication
(10) Pub. No.: US 2008/0066139 A1
(43) Pub. Date: Mar. 13, 2008

(54) TELEVISION, TELEVISION BOX, AND APPARATUS FOR TRANSMITTING A MULTIMEDIA STREAM TO A REMOTE DEVICE

(75) Inventor: Bo-Wen Tsai, Hsinchu (TW)

Correspondence Address: HOLLAND & KNIGHT LLP, 10 ST. JAMES AVENUE, 11th Floor, BOSTON, MA, 02116-3889, US

(73) Assignee: NEW SILICON, INC., Taipei (TW)

(21) Appl. No.: 11/851,911

(22) Filed: Sep. 7, 2007

(30) Foreign Application Priority Data
Sep. 7, 2006 (TW) 095215879
May 30, 2007 (TW) 096208878

(51) Int. Cl. H04N 7/16

(52) U.S. Cl. 725/139

(57) ABSTRACT

TV, TV box, and apparatus for transmitting a multimedia stream to a remote device are provided, wherein all of them are connected to Internet. The TV box comprises a control unit, a data transform module, and a TV process unit. The data transform module transforms the multimedia stream into a plurality of Internet packets. The control unit transforms the Internet packets to the remote device through the Internet. The TV process unit generates a display signal in response to the multimedia stream so that a display unit can display an image relating to the multimedia stream. The TV comprises the TV box and the display unit. The apparatus comprises the control unit, the data transform module, the public switched telephone network, and the user interface. Consequently, various techniques are integrated and multimedia stream can be transmitted to a remote device.

### CROSS-REFERENCE TO RELATED APPLICATIONS

This application claims priority to Taiwan Patent Application No. 095215879, filed 7 Sep. 2006, and Taiwan Patent Application No. 096208878, filed 30 May 2007, the entire contents of which are herein incorporated by reference in their entirety.

### BACKGROUND OF THE INVENTION

1. Field of the Invention

The present invention relates to a television, a television box, and a multimedia redirecting and communication apparatus. More particularly, the present invention relates to a television, a television box, and a multimedia redirecting and communication apparatus that have the multimedia redirecting, the public switch telephone network (PSTN), the network telephone, the network video telephone and the video playing functions integrated together.

2. Descriptions of the Related Art

Widespread and frequent use of television in the twentieth century has proven its indispensability to people's life and entertainment. It is a pity that sometimes people may not be able to favorite programs due to the inaccessibility of the TV. For example, missing a live broadcast of a ball game or failing to receive a Taiwan TV program when traveling abroad. On the other hand, as an important communication means for the general people, telephones can help people at various places to communicate with each other.

Driven by continuous development of Internet and multimedia technologies, the network telephone technology becomes increasingly sophisticated. However, application of this technology has been restricted in offices as an option for enterprises to cut telephone bills. Furthermore, although many TV stations are providing network TV services, the programs they can provide is very limited. Consequently, under restrictions of the current architecture, the network telephone and network TV cannot be a popular communication and multimedia playing means in a home.

According to the aforementioned description, an audio stream, a video stream, the PSTN, the Internet, and TV functions are expected to be integrated together in order to facilitate people's daily life significantly.

### SUMMARY OF THE INVENTION

One objective of this invention is to provide a television for transmitting a multimedia stream to a remote device. The television is connected to an Internet. The television comprises a data transformation module, a control unit, a television processing unit, and a display unit. The data transformation module is configured to transform the multimedia stream into a plurality of multimedia packets. The control unit is connected to the data transformation module for transmitting the multimedia packets to the remote device through the Internet. The television processing unit is configured to generate a display signal in response to the multimedia stream it receives, and the display unit is configured to play an image resulting from the multimedia stream in response to the display signal it receives.

Another objective of this invention is to provide a television box for transmitting a multimedia stream to a remote device. The television box is connected to an Internet. The television box comprises a data transformation module, a control unit, and a television procession unit. The data transformation module is configured to transform the multimedia stream into a plurality of multimedia packets. The control unit is connected to the data transformation module for transmitting the multimedia packets to the remote device through the Internet. The television processing unit is configured to generate a display signal in response to the multimedia stream it receives, so that a display unit is able to play an image resulting from the multimedia stream in response to the display signal.

Yet another object of this invention is to provide a multimedia redirecting and communication apparatus for redirecting an input multimedia stream to a remote device and integrating a communication over a public switched telephone network (PSTN) with a communication over an Internet. The multimedia redirecting and communication apparatus comprises a control unit, a data transformation module, a PSTN processing unit, and a user interface circuit. The control unit is configured to execute a first Internet communication program to enable the communication over the Internet and redirection of the multimedia stream. The control unit comprises a microprocessor, a network control circuit, and a storage module. The microprocessor is configured to execute the first Internet communication program according to a status of the PSTN, a status of the Internet and a user setting. The network control circuit is connected to the microprocessor and the Internet to control transmission and reception of a plurality of network packets. The storage module is connected to the microprocessor to allow for data access and temporary storage of the plurality of network packets. The data transformation module is connected to the control unit to transform the Internet packets and the multimedia stream. The PSTN processing unit is connected to a PSTN interface and the control unit to place or receive a call over the PSTN. The user interface circuit is configured to receive/transmit a user message or display a user state, wherein the user interface circuit comprises an input unit and an output unit connected to the PSTN processing unit and the control unit.

The television, the television box, and the multimedia redirecting and communication apparatus of this invention can transmit a multimedia stream received from a local device (e.g., a TV program received via an antenna and/or a cable, or a multimedia file transmitted from a player) to a remote device through an Internet. In this way, a user of the remote device is also allowed to watch an image resulting from the multimedia stream provided by the television and television box.

With the Internet as a transmission medium, this invention allows further integration of other multimedia and/or communication applications, such as PSTN, network call, network video call, image playing, and so on. As a result, consumers' needs to watch desired TV programs in any place and to utilize the network telephone function for communication fee saving are both satisfied.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts a schematic architecture of a first embodiment of this invention;

FIG. 2 depicts a schematic architecture of a second embodiment of this invention;

FIG. 3 depicts a detailed architecture of a data transformation module;

FIG. 4 depicts a schematic architecture of a third embodiment of this invention;

FIG. 5 depicts a schematic architecture of a fourth embodiment of this invention;

FIG. 6 depicts a schematic architecture of a fifth embodiment of this invention;

FIG. 7 depicts a schematic architecture of a sixth embodiment of this invention; and

FIG. 8 depicts a schematic architecture of a seventh embodiment of this invention.

### DESCRIPTION OF THE PREFERRED EMBODIMENT

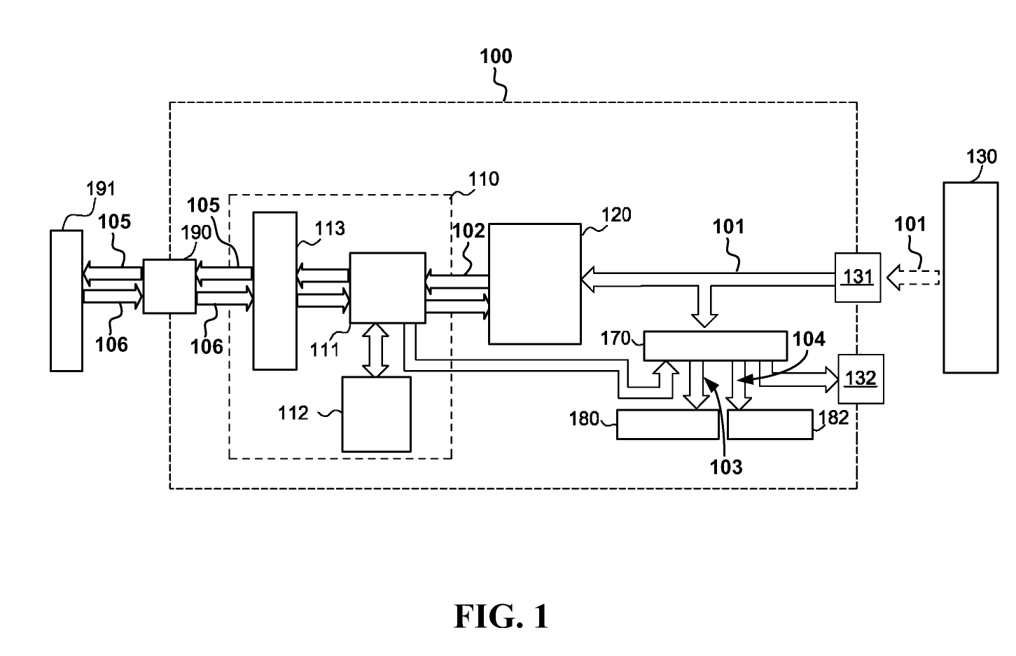

A first embodiment of this invention is a television 100 with multimedia redirecting and communication functions, and an architecture of which is depicted in FIG. 1. More specifically, being connected to an Internet, the television 100 is able to both transmit a multimedia stream 101 to a remote device 191 through the Internet and transform network packets from the Internet into a multimedia stream. Here, the remote device 191 may be a desktop computer, a notebook computer, a flat panel computer, a personal digital assistant (PDA), a digital multimedia player, a handset, and so on.

The television 100 comprises a data transformation module 120, a control unit 110, a television (TV) processing unit 170, a display unit 180, and a speaker 182. The data transformation module 120 is configured to transform the multimedia stream 101 into a plurality of multimedia packets 102. The control unit 110, being connected to the data transformation module 120, is configured to interface with the Internet through a network port (i.e., an RJ-45 network port 190), in order to transmit the multimedia packets 102 to the remote device 191. In other embodiments, the control unit 110 may also interface with the Internet through other media, such as a wireless network card. In other words, the scope of this invention is not limited by the particular medium used to interface with the Internet. The TV processing unit 170 is configured to generate a display signal 103 and an audio signal 104 in response to the multimedia stream 101 it receives. In this embodiment, the TV processing unit 170 comprises an infrared receiving unit (not shown) for receiving a control signal from an infrared remote controller (not shown). The display unit 180 is configured to play an image resulting from the multimedia stream in response to the display signal 103 it receives, while the speaker 182 is configured to play a speech associated with the multimedia stream in response to the audio signal it receives. In other embodiments, the infrared receiving unit and/or the speaker may be omitted.

Continuing to refer to FIG. 1, the control unit 110 comprises a microprocessor 111, a storage module 112, and a network control circuit 113. The microprocessor 111 is configured to execute a first Internet communication program and perform data processing according to a status of the Internet and a user setting. The storage module 112 is connected to the microprocessor 111 to temporarily store the network packets 102 and to access data. The network control circuit 113, being connected to the microprocessor 111 and the Internet, is configured to transmit the multimedia packets and to receive the network packets. Functions and operations of the microprocessor 111, the storage module 112, and the network control circuit 113 are well know to those of ordinary skill in the art, and will not be described herein. The control circuit 113, the microprocessor 111, and the storage module 112 may be made as individual units or be integrated into a same chip.

In particular, the television 100 further comprises an input video/audio port 131 and an output video/audio port 132, so that the data transformation module 120 can receive a multimedia stream 101 from a video/audio source system 130 through the input video/audio port 131. Here, the multimedia stream 101 may be in either an analog or a digital form. The video/audio source system 130 may take on a variety of forms, such as a DVD player, a digital set top box, various game consoles, and so on. The input video/audio port 131 may be an analog input video/audio port, such as a coaxial radio frequency (RF) connector port for cable television, an analog television antenna, an AV terminal, an S terminal, and so on. In other embodiments, the input video/audio port 131 may also be a digital input video/audio port, such as a digital visual interface (DVI) port. As to the output video/audio port 132, it is configured to output a display signal and/or an audio signal generated by the TV processing unit 170. The output video/audio port 132 supports a common video/audio interface, such as an HDMI port, a DVI port, a display port, an AV terminal port, an S terminal port, and so on. It should be noted that, the input video/audio port 131 and the output video/audio port 132 are not merely limited to the aforesaid ports, and other existing or future video/audio ports may also be suitable for implementing the concepts of this invention.

It is assumed in this embodiment that, the video/audio source system 130 is a DVD player, and the television 100 and the remote device 191 have both been connected to the Internet. Here, the television 100 is connected to the Internet through the first Internet communication program that supports the Internet Protocol (IP), while the remote device 191 is connected to the Internet through a second Internet communication program that supports the IP. The following description will describe a way for the television 101 to redirect a multimedia stream, that is, a specific way to transmit the multimedia stream 101 to the remote device 191 through the Internet and to transform network packets from the Internet into a multimedia stream.

This description begins with transmission of the multimedia stream 101 to the remote device 191 through the Internet. The television 100 of this embodiment receives the multimedia stream 101 comprising an audio stream and a video stream from the video/audio source system 130 (i.e., a DVD player) through the input video/audio port 131. Subsequently, the data transformation module 120 transforms the multimedia stream 101 into a plurality of multimedia packets 102 comprising a plurality of video packets and a plurality of audio packets. In particular, in order to encode the video stream, the data transformation module 120 supports a video compression standard, which may be an MPEG4 (motion picture experts group 4) standard, an H.264 standard, a 3GPP (3^{rd} generation partnership project) standard, or an unpublished proprietary video compression standard defined by a manufacturer. Similarly, in order to encode the audio stream, the data transformation module 120 also supports an audio compression standard, which may be an adaptive multi-rate (AMR) standard, an adaptive differential pulse code modulation (ADPCM) standard, or an unpublished proprietary audio compression standard defined by a manufacturer. It should be noted that, the video and audio compression standards in this invention are not merely limited to those described above, and other existing or future video and audio compression standards may be suitable for implementing the concepts of this invention.

Subsequently, the control unit 110 assembles the multimedia packets 102 (i.e. the video packets and audio packets) into a number of first network packets 105, which are then transmitted to the remote device 191 through the Internet by use of the first Internet communication program. Thus, transmission of the multimedia stream 101 from the television 100 to the remote device 191 through the Internet is thus completed. On the other hand, the remote device 191 is configured to play images and audios included in the multimedia stream through decoding these first network packets 105. In this way, as long as the remote device 191 is connected to the Internet, a user of the remote device 191 can watch movies played by a DVD player located at home no matter wherever he or she is.

Next, transformation of network packets received from the Internet into a multimedia stream will be described. The television 100 is also capable of receiving a plurality of second network packets 106 from the Internet through an RJ-45 network port 190, wherein the second network packets 106 may be a user image (e.g., in case of a network video telephone) transmitted from the remote device 191 or an image transmitted from a multimedia source (e.g., the MOD for network television of the Chunghwa Telecom Co., Ltd) connected to the Internet. The control unit 110 decodes the second network packets by use of the data transformation module 120, and transmits the decoded data to the TV processing unit 170. The TV processing unit 170 processes the decoded data for playing via the display unit 180 and the speaker 182.

A user of the television 100 can now control the TV processing unit 170 with an infrared remote controller to watch the multimedia stream 101 from the video/audio source system 130 (i.e., a DVD movie played by a DVD player), a user image transmitted from the remote device 191, or the network TV. In response to one of these multimedia signals, the TV processing unit 170 generates a corresponding video signal and a corresponding audio signal, which are then transmitted to the display unit 180 and the speaker 182 respectively for displaying an image and playing a speech. Here, the display unit 180 may be a cathode ray tube (CRT) display, a flat panel display, a liquid crystal display (LCD), or an organic light emitting diode (OLED), and so on.

With such a configuration, the television 100 of the first embodiment is provided with multimedia redirecting and Internet connecting functions, so that it can not only receive video images from the Internet but also transmit multimedia images from a local device (e.g., a DVD player, a cable/wireless TV program) to a remote device. As a result, in contrast to the simple functions provided by a conventional television, both a local and a remote user can have access to a number of video image sources.

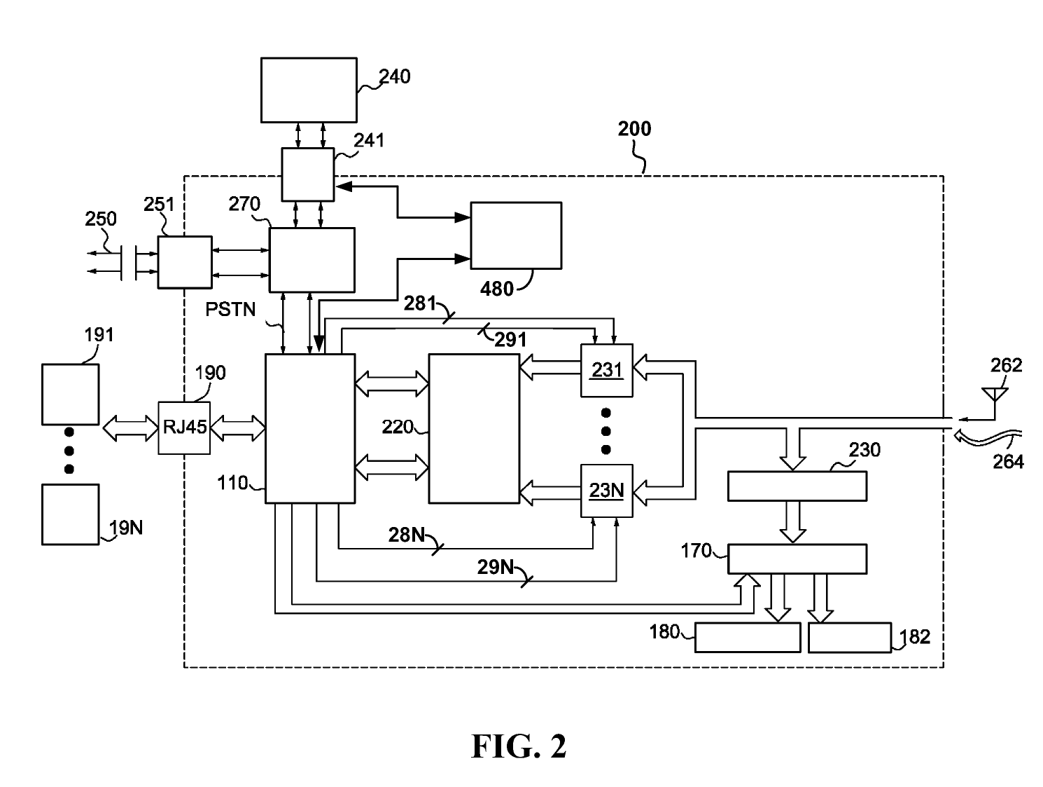

A second embodiment of this invention is a television 200 with multimedia redirecting and communication functions, an architecture of which is depicted in FIG. 2. The television 200 comprises a control unit 110, a PSTN processing unit 270, a data transformation module 220, N+1 television tuners 230-23N (wherein N is a positive integer, and N≧1), a TV processing unit 170, a display unit 180, a speaker 182, an RJ-45 network port 190, a first PSTN port (i.e., a first RJ-11 port 241), and a second PSTN port (i.e., a second RJ-11 port 251). The television 200 of the second embodiment is provided with all functions of the television 100 of the first embodiment, and therefore only different functions will be described below.

A user interface circuit 240 is electrically connected to the PSTN processing unit 270 through the first RJ-11 port 241, that is, the first RJ-11 port 241 has one end connected to the user interface 240 and has the other end connected to the PSTN processing unit 270. In this embodiment, the user interface 240 is a telephone, while in other embodiments, the user interface 240 can be integrated into the television 200.

The television 200 is configured to execute a first Internet communication program, in order to be connected to the Internet through the RJ-45 port 190. The first Internet communication program is just the same as that in the first embodiment, and therefore will not be described herein. A user can input a user signal through the user interface 240 to place a call via the telephone. In response to the user signal, the user interface circuit 240 transmits a first communication request signal associated with the dialed telephone number to the PSTN processing unit 270 through the first RJ-11 interface 241, and then the PSTN processing unit 270 receives the first communication request signal.

Since the control unit 110 is electrically connected to the PSTN processing unit 270, the first communication request signal associated with the dialed telephone number can be transmitted to the control unit 110 through the PSTN processing unit 270. In response to the first communication request signal and by use of the first Internet communication program described above, the control unit 110 transmits a second communication request signal through the Internet, that is, dials the telephone number in a network dial-up way. In general, the Internet communication programs supporting the Internet Protocol have two dial-up modes: one is the peer to peer mode, and the other is the Internet to PSTN mode, wherein the latter can be used to dial home telephones or mobile phones.

The television 200 of this embodiment further provides another kind of PSTN connection, so that the user can have more options when dialing a telephone number. Specifically, the second RJ-11 port 251 of the television 200 is electrically connected to the PSTN processing unit 270 and the PSTN 250. The control unit 110 can instruct the PSTN processing unit 270 to transmit a second communication request signal to the PSTN 250 via the second RJ-11 interface 251. The PSTN processing unit 270 ensures the connectivity to the PSTN 250, so the user can dial an emergency call in any case.

According to the above description, it is known that the television 200 of the second embodiment provides two ways for dialing a telephone number. Thus, a successful communication can be achieved no matter whether the called party is on the PSTN or on the Internet.

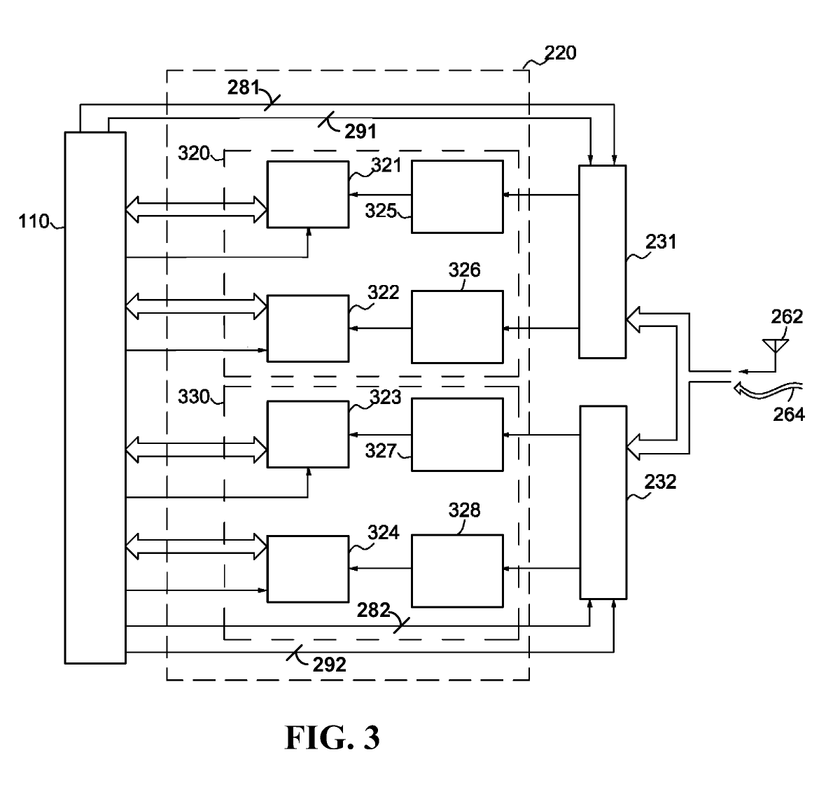

The following description relates to a specific way to process the audio signal after a telephone connection is established successfully, when the user dials a telephone number through the Internet. Refer to FIG. 3, a schematic view of the detailed structure of the data transformation module 220 is depicted therein. The data transformation module 220 comprises two coding/decoding (codec) devices 320, 330. The codec device 320 comprises an audio codec unit 321, a video codec unit 322, a first analog-digital/digital-analog (AD/DA) converter 325 connected to the audio codec unit 321, and a second AD/DA converter 326 connected to the video codec unit 322. Similarly, the codec device 330 comprises an audio codec unit 323, a video codec unit 324, a first AD/DA converter 327 connected to the audio codec unit 323, and a second AD/DA converter 328 connected to the video codec unit 324. The audio codec unit 321, 323 and the video codec unit 322, 324 are all connected to the control unit 110.

It is assumed herein that the user has established a telephone connection through the Internet. With such a connection, an analog audio stream spoken by the user (i.e., speech of the user) to the microphone is transmitted to the first AD/DA converter 325 and/or 327. The control unit 110 instructs the first AD/DA converter 325 and/or 327 to transform the analog audio stream into a digital audio stream. The digital audio stream is transmitted to the audio codec unit 321 and/or 323. The audio codec unit 321 and/or 323 encodes the digital audio stream according to a first and/or a second audio control signal (being set by the control unit 110 to encoding operation). That is, the digital audio stream is encoded into an AMR format, an ADPCM format, or an unpublished proprietary audio compression standard defined by the manufacture. Then, as described in the first embodiment, the control unit 110 assembles the encoded audio stream into a plurality of network packets, and uses the first Internet communication program to transmit them through the RJ-45 network port 190 to the Internet and finally to one or a combination of the remote devices 191˜19N (each of which maybe a telephone). It should be emphasized that the audio compression standards in this invention are not limited to those described above, and other existing or future audio compression standards may be suitable for implementing the concepts of this invention.

The remote devices 191˜19N, which maybe telephones, execute a second Internet communication program respectively so as to connecting to the Internet. Then, voices from users at the remote devices 191˜19N is transmitted by the second Internet communication program through the Internet back to the control unit 110 in the form of network packets. Next, the control unit 110 generates a first and/or a second audio control signal (be set for decoding operation). In response to the audio control signal(s), the audio codec unit 321 and/or 323 decodes the network packets to derive a decoded audio signal for transmitting to the control unit 110. Finally, the control unit 110 transmits these decoded audio signals via the PSTN processing unit 270 to the telephone 240. At this point, the user of the telephone will be able to hear a speech transmitted from one or a combination of the remote devices 191˜19N (each of which maybe a telephone).

It is noted that in other embodiments the user interface 240 may comprise an AD/DA converter (not shown) and the television 200 may further comprise an additional audio codec unit 480 to accomplish the functions described above. In more detail, the analog audio stream (i.e., speech of the user) spoken by the user to the microphone can be converted into a digital audio stream by the AD/DA converter included in the user interface 240, and then be transmitted to the audio codec unit 480 to be encoded into a plurality of network packets. Next, the control unit 110 transmits the network packets to the remote devices 191˜19N (e.g., telephones). Similarly, the user voices transmitted from the remote devices 191˜19N are also directly processed by the AD/DA converter of the user interface 240 and the additional audio codec unit 480 of the television 200. In other words, in such an embodiment, the first AD/DA converter 325, 327 and the audio codec unit 321, 323 in the data transformation module 220 are free and can be dedicated to the following tasks.

The demodulating functions of the television 200 in the second embodiment are now described. The television 200 described above comprises N+1 television tuners 230˜23N, and for purpose of simplicity, the following description will take N=2 as an example. One of these television tuners 230˜232 (i.e. television tuner 230) is electrically connected to the TV processing unit 170, while other television tuners 231,232 are electrically connected to the codec units 320, 330.

Through a cable 264 such as a digital cable or an analog cable, or through an antenna 262 (for example, in case of digital terrestrial video broadcast, analog terrestrial video broadcast or satellite broadcast), the respective television tuners 230˜232 of the television 200 may receive a multimedia stream and choose one channel therefrom, thereby to generate a demodulated video stream and a demodulated audio stream. Particularly, the television tuner 230 then transmits the demodulated video stream and the demodulated audio stream to the TV processing unit 170. The subsequent processing is just the same as in the first embodiment, and hence will not be described again.

Now, a detailed description will be made on specific operations of the television tuners 231, 232 following the aforesaid operations of receiving a multimedia stream, choosing one channel in response to respective tuning signals and generating a demodulated video stream and a demodulated audio stream. The television tuners 231, 232 then transmit respective demodulated video streams and demodulated audio streams to the codec units 320, 330 of the data transformation module 220 respectively.

Here, it is presumed that the television tuners 231, 232 correspond to two remote device 191, 192 (N=2). With this invention, users of the remote devices 191, 192 can not only watch programs whatsoever they initially received via the television tuners 231, 232 passively, but also can choose television channels actively as desired. This is accomplished by transmitting the user settings (including a tuning setting and/or a switching setting) back to the control unit 110 through the second Internet communication programs loaded in the remote devices. Upon receiving the user settings, the control unit 110 operates to change the channels of the television tuners 231, 232 through a respective tuning signal according to the users' tuning settings, and may also operate to switch on/off the television tuners 231, 232 through a respective on/off signal according to the switching settings. Specifically, the remote device 191 can switch on/off the television tuner 231 through a first switching signal 281, and can also choose a desired channel through a first tuning signal 291. Similarly, the remote device 192 can switch on/off the television tuner 232 via a first switching signal 282, and can also choose a desired channel via a first tuning signal 292.

Taking the remote device 191 as an example, once the user choose a specific channel, the multimedia stream will be transmitted to the first AD/DA converter 325 and the second AD/DA converter 326 for respective audio and video conversion. The converted data is further transmitted to the audio codec unit 321 and the video codec unit 322 respectively. Then the audio codec unit 321 encodes an audio stream of the multimedia stream in response to the first audio control signal, while the video codec unit 322 connected to the control unit encodes a video stream of the multimedia stream in response to the first video control signal. The subsequent operations are just the same as in the first embodiment, and hence will not be described again.

Thus, with the architecture of multiple television tuners of this embodiment, audience of the display unit 180 and users of the remote devices 191, 192 can enjoy their respective favorite programs without interference to each other.

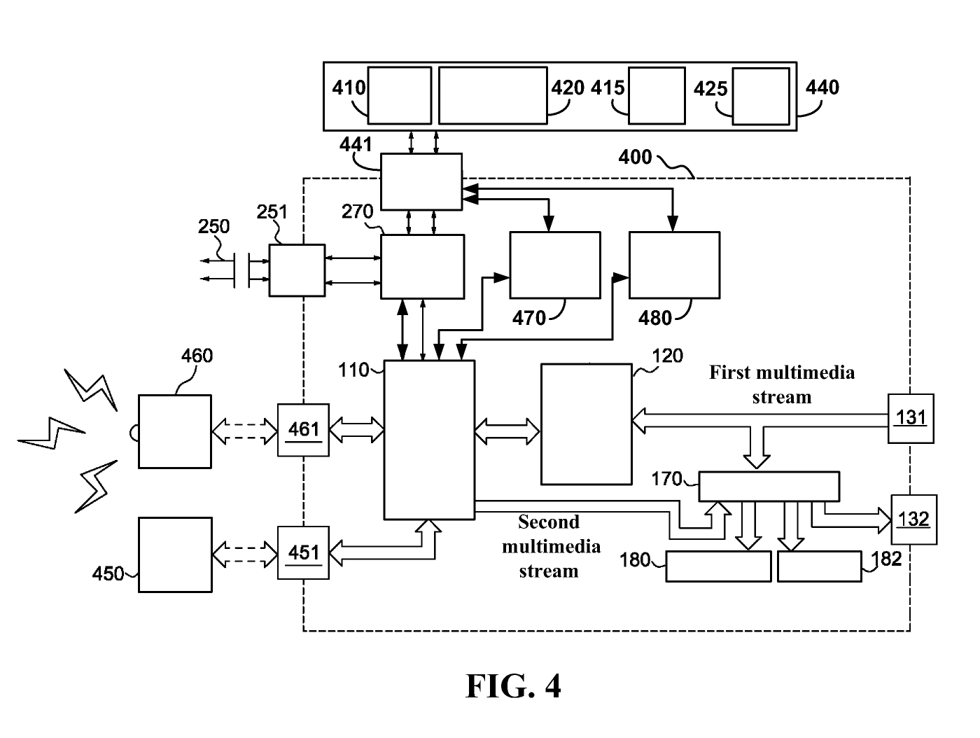

A third embodiment of this invention is another television 400 with a multimedia redirecting and communication capability, a schematic architecture of which is depicted in FIG. 4. The television 400 comprises a control unit 110, a PSTN processing unit 270, a data transformation module 120, a TV processing unit 170, a display unit 180, a loudspeaker 182, two slots 451, 461, a first telephone line port 441, a second telephone line port (i.e., the aforesaid second RJ-11 port 251), a video codec unit 470, and an audio codec unit 480. A user interface 440 is connected to the television 400. The user interface 440 comprises a LCD module 410, a press key 415, an image extraction unit 420, and a microphone 425. This embodiment is partially the same as previous embodiments, so the following descriptions will focus only on the distinct portions.

A wireless fidelity (as known as WiFi) card 460 is inserted into the slot 461, which is electrically connected to a microprocessor 111 (not shown in FIG. 4) of the control unit 110. The microprocessor 111 executes the aforesaid first Internet communication program to transmit a plurality of network packets through the slot 461 to the WiFi card 460, wherein the plurality of network packets are transmitted wirelessly through the Internet to remote devices. The slot 461 is configured to support a Secure Digital Input/Output (SDIO) interface standard, a Universal Serial Bus (USB) interface standard, etc., in order to accommodate the WiFi card 460. It should be noted that, in other embodiments, an RJ-45 network port 190 may be provided together with the slot 461 to connect with the Internet, so as to provide the user with both wired and wireless networking options.

The other slot 451 may be connected to an external storage medium 450, such as a USB storage device, a hard disk, a memory card, and so on. The slot 451 may support the SDIO interface, the USB interface, or one or a combination of the following interfaces: a Compact Flash (CF) card interface, a memory stick interface, a picture card interface, a Smart Media (SM) card interface, a microdrive interface, or a Multi Media Card (MMC) interface.

By use of the user interface 440, the user can dial a telephone number using the press keys 415, with reception and/or transmission of speech being accomplished by the microphone 425. The image extraction device 420 is configured to extract a user image for transmitting through the telephone line port 441 to the video codec unit 470 to be decoded therein. Thereafter, the encoded user image is transmitted to a remote device under the control of the control unit 110. The microphone 425 is configured to receive an audio stream (i.e., speech from the user), which is then transmitted through the telephone line port 441 to the audio codec unit 480 to be encoded therein. Thereafter, the encoded audio stream is transmitted also to the remote device under the control of the control unit 110.

The LCD module 410 comprises an LCD control unit (not shown) and an LCD (also not shown). The LCD control unit is configured to receive a decoded video signal or a usage message from the control unit 110, and the LCD is configured to display the decoded video signal or the usage message. The data transformation module 120 decodes the network packets transmitted from the Internet to generate the decoded video signal.

It should be noted that, in other embodiments, the user interface 440 may be disposed inside the television 400, in which case the LCD module 410 may be replaced by the display unit 180.

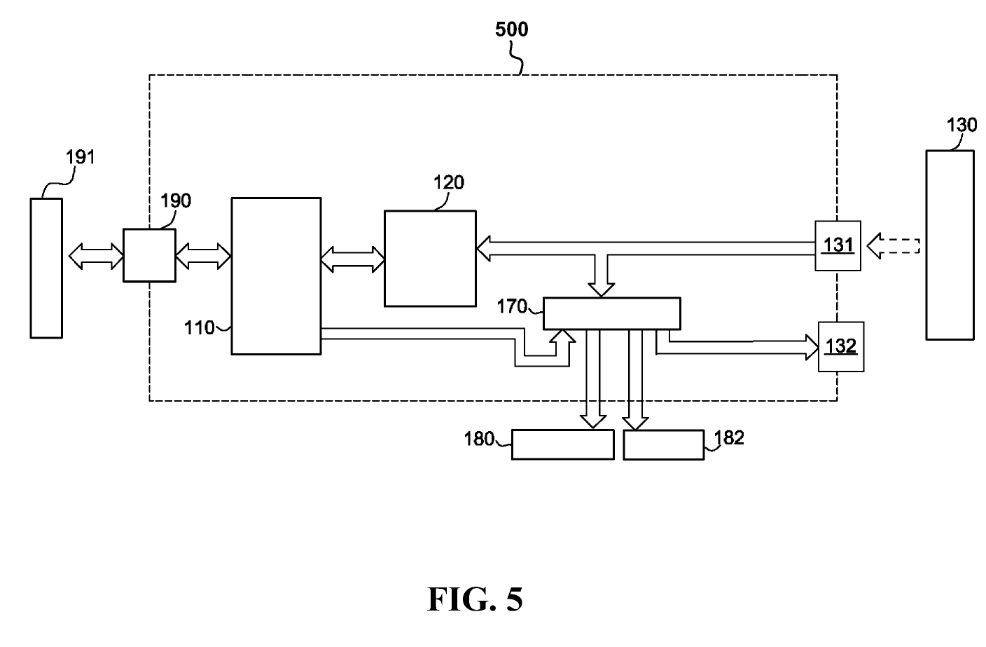

A fourth embodiment of this invention is a television box 500 with a multimedia redirecting and communication capability, a schematic architecture of which is depicted in FIG. 5. The television box 500 of this embodiment comprises a control unit 110, a data transformation module 120, a TV processing unit 170, an RJ-45 network port 190, an input video/audio port 131, and an output video/audio port 132.

The television box 500 differs from the previous embodiments mainly in that the television box 500 does not comprise a display unit and a loudspeaker. In other words, the television box 500 is composed of components of the first embodiment other than the display unit 180 and the loudspeaker 182, and therefore has all functions of the television 100 except for those of the display unit 180 and the loudspeaker 182. In case it is required to play a video and an audio stream, the television box 500 can connect to an external display unit and a loudspeaker.

Similarly, in other embodiments, components of the second embodiment other than the display unit 180 and the loudspeaker 182 may operate independently as another television box, and/or components of the third embodiment other than the display unit 180 and the loudspeaker 182 may also operate independently as yet another television box.

It should be noted that, for purpose of description, individual multimedia streams from the video/audio source system 130, the cable, and the antenna are separate from each other in the above embodiments. Under the assumption that respective hardwares can support each other, a plurality of sources may be equipped to provide multimedia streams. That is, in other embodiments, in addition to multimedia streams from the cable or the antenna, a video/audio port (e.g., an S terminal or an AV terminal) may also be provided to receive a multimedia stream from the video/audio source system 130. Then, the user can control the TV processing unit 170 by an infrared remote controller to choose a multimedia stream from the aforementioned sources (the video/audio source system 130, the cable 264, or the antenna 262), a user image from the remote device (the network video telephone), and/or a file transmitted from a certain multimedia source over the network (e.g., the MOD for network television of the Chunghwa Telecom Co., Ltd).

In summary, with the PSTN, the Internet, and the video/audio source system being interconnected, this invention may not only have the PSTN communication, the Internet communication and the television playing functions integrated together, but also allow people to watch (listen) multimedia programs no matter wherever they are. Moreover, the present invention can be achieved with a simple hardware structure and a relatively hardware low cost, which renders this invention very suitable for mass production and commercialization.

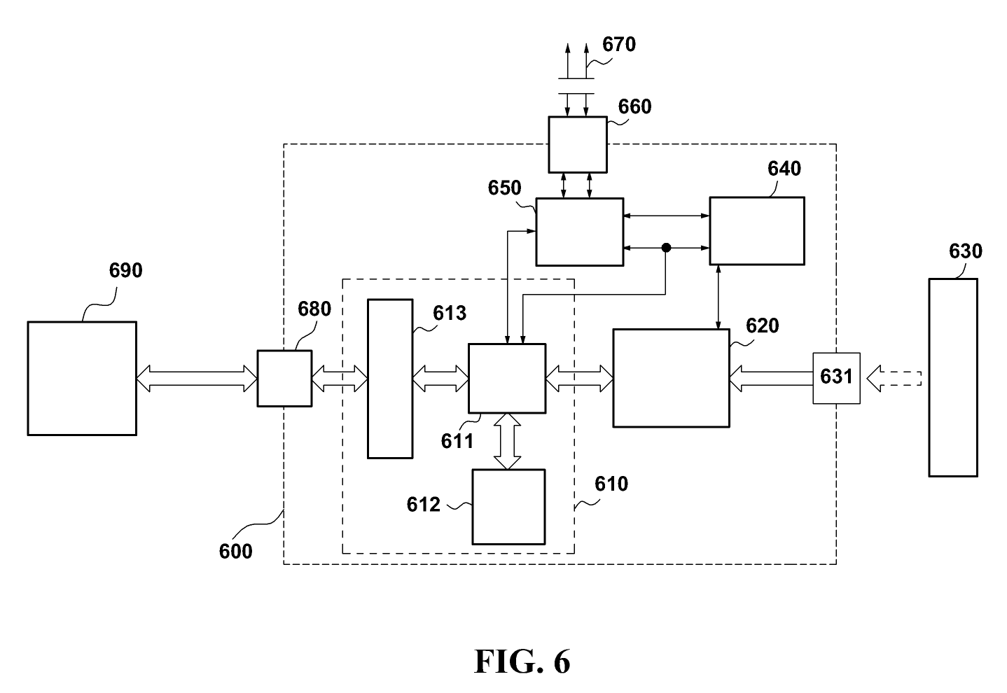

Referring to FIG. 6, a schematic structure of a fifth embodiment of this invention is depicted. A multimedia redirecting and communication apparatus 600 of this invention comprises a control unit 610, a data transformation module 620, a user interface circuit 640, and a PSTN processing unit 650. The control unit 610 is connected to an Internet via an RJ-45 network port 680, which is configured to facilitate network communication and redirection of an input multimedia stream (fed by a video/audio source system 630). The data transformation module 620 is connected to the control unit 620, which is configured to decode network packets transmitted from the Internet and encode the input multimedia stream, and may be implemented in hardware or software when the multimedia stream is in a digital form. The user interface circuit 640 is connected to a PSTN processing unit 650 and the control unit 610, which is configured to receive/transmit a user message or to display a current status of the apparatus 600, a remote device 690 or the communication. The PSTN processing unit 650 is connected to a PSTN 670 via an RJ-11 port 660, which is configured to make or receive a call over the PSTN.

Continuing to refer to FIG. 6, the control unit 610 comprises a microprocessor 611, a storage module 612, and a network control circuit 613. The microprocessor 611 is configured to execute a first Internet communication program and perform data processing, the implementation of which is well-known to those skilled in the art and therefore will not be described herein. The storage module 612 is coupled to the microprocessor 611 for data access. In this embodiment, the storage module 612 comprises a non-volatile storage unit such as a flash memory and a volatile storage unit such as a dynamic random access memory (not shown). In addition, the implementation of the storage module 612 is well-know to those skilled in the art and will not be described herein. The network control circuit 613 is coupled to the microprocessor 611 and the Internet to control transmission and reception of network packets, the implementation of which is also well-known to those skilled in the art and therefore will not be described herein. The network control circuit 613, the microprocessor 611 and the storage module 612 may either be individual units separated from each other or be integrated into a single chip.

On the other hand, the video/audio source system 630 transmits a multimedia stream in an analog or digital format to the data transformation module 620 via a video/audio port 631. Although transmission interfaces in a complete digital format have already been available at present, analog transmission interfaces are still the most popular ones. There exists a variety of forms for the video/audio source system, such as a DVD player, a set top box, a TV cable, and even various game consoles. Here, the video/audio port 631 may be an analog video/audio port, such as a coaxial RF connector port for cable TV, an analog TV antenna port, an AV terminal, an S terminal, and so on. Alternatively, the video/audio port 631 may also be a digital video/audio port, such as a digital visual interface (DVI) port. In another embodiment of this invention, the video/audio source system 630 may be an audio source system, such as a CD player (in which case the mating video/audio port 631 may become an analog audio port such as a tip ring sleeve (TRS) port) or a digital audio port, such as a Sony/Philips digital interface format (S/PDIFP) port. It should be noted that, application of this invention is not merely limited thereto, and other existing or future video/audio ports or audio ports may be suitable for use with the concepts of this invention. Under the assumption that the video/audio source system 630 is a DVD player and both the multimedia redirecting and communication apparatus 600 and the remote device 690 have already been connected to the Internet, a brief description will be made on the multimedia redirecting operation. Upon receiving a multimedia stream (including an audio stream and a video stream) from a DVD player via the video/audio port 631, the data transformation module 620 compresses and encodes the multimedia stream. The encoded video stream may support a published video compression standard, such as an MPEG4 (motion picture experts group 4) standard, an H.264 standard or a 3GPP (3^{rd} generation partnership project) standard, or an unpublished proprietary video compression standard defined by the manufacturer. Similarly, the encoded audio stream may support a published audio compression standard, such as an adaptive multi-rate (AMR) standard or an adaptive differential pulse code modulation (ADPCM) standard, or an unpublished proprietary audio compression standard defined by the manufacturer. However, application of this invention is not merely limited thereto, and other existing or future video or audio compression standards may be suitable for use with the concepts of this invention.

Subsequently, the control unit 610 assembles the encoded video stream and the encoded audio stream into a plurality of network packets. The network packets are then transmitted by the first Internet communication program supporting IP, such as a session initiated protocol (SIP) to the remote device 690 (loaded with a second Internet communication program that also supports the IP (e.g., the SIP)) through the Internet. Finally, the remote device 690 decodes these network packets to play a movie from the DVD player. In this way, so long as the remote device 690 has access to the Internet, a user of the remote device 690 can watch movies played by a DVD player located at home no matter wherever he or she is. Here, the remote device 690 may be a desk-top computer, a notebook computer, a flat panel computer, a PDA, a digital multimedia player, a handset, and so on.

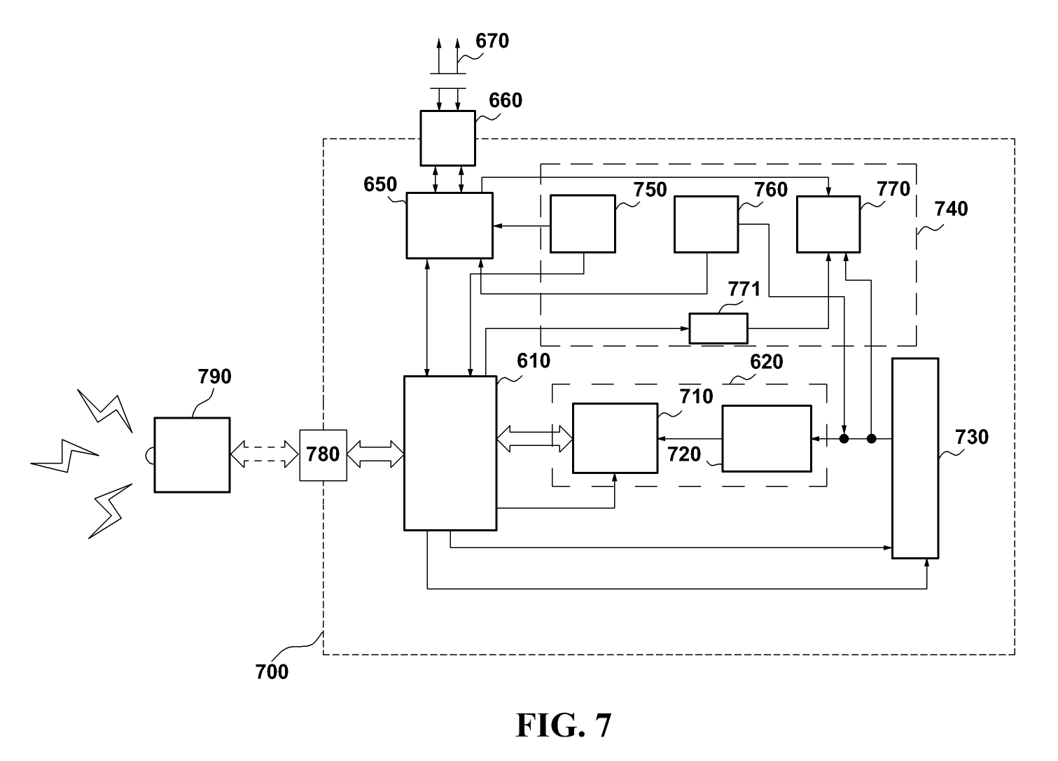

Referring to FIG. 7, a schematic structure of a sixth embodiment of this invention is depicted. A multimedia redirecting and communication apparatus 700 of this invention comprises a control unit 610, a PSTN processing unit 650, an audio codec unit 710, an AD/DA converter 720, a radio tuner 730, a telephone keyboard 750, a microphone 760, a loudspeaker 770, a D/A converter 771, a slot 780, and an RJ-11 port 660.

Compared to the fifth embodiment, the user interface circuit 740 in the sixth embodiment is a conventional telephone receiver, which comprises a telephone keyboard 750, a microphone 760, and a loudspeaker 770. Furthermore, the data transformation module 620 is implemented by an audio codec unit 710 and an AD/DA converter 720. With the PSTN communication and the Internet communication being integrated in this invention, an output terminal of the telephone keyboard 750 is connected not only to the PSTN processing unit 650, but also to the control unit 610, thereby to place a call through the Internet communication program described above. Similarly, an output terminal of the microphone 760 is connected not only to the PSTN processing unit 650, but also to the AD/DA converter 720.

In case the apparatus 700 is powered off or fails to connect to the Internet, the PSTN processing unit 650, which receives power only from the PSTN 670 and has an initial enabled state, may also guarantee the connectivity to the PSTN 670, so that the user can dial an emergency call such as 610, 119 in any event. Once the apparatus 700 resumes its connection to the Internet, the control unit 610 will disable the PSTN processing unit 650 through a second switching signal. Then, the telephone numbers that the user subsequently dials by the telephone keyboard 750 will be forwarded directly to the control unit 610, which then place a call via the first Internet communication program. Generally, the Internet communication programs supporting the Internet Protocol have two dial-up modes: one is the peer-to-peer mode and the other is the Internet to PSTN mode, wherein the latter can be used to dial home telephones or mobile phones. In this way, a successful communication can always be achieved no matter whether the called party is on the PSTN or on the Internet.

If the apparatus 700 has already been connected to the Internet and the user makes a speech into the microphone 760, the AD/DA converter 720 operates to convert the analog audio stream into a digital stream, which is then be encoded by the audio codec unit 710 according to an audio control signal (being set for encoding operation) into an AMR format, an ADPCM format, or a proprietary audio compression format. Thereafter, the encoded audio stream is divided into a plurality of network packets by the control unit 610 and then transmitted through the slot 780 to a WiFi card 790, wherein these network packets are transmitted wirelessly to the Internet and finally to the remote device 690 of FIG. 6.

Here, the slot 780 is connected to the microprocessor 611 (not shown) of FIG. 6 and supports one of an SDIO interface standard and a USB interface standard, in order to accommodate the WiFi card described above. It should be noted that, in another embodiment of this invention, the RJ-45 network port 680 may be provided with the slot 780 to connect with the Internet, so as to provide the user with both wired and wireless networking options. When the user chooses to connect to the Internet by the slot 780 and the WiFi card 790, the RJ-45 network port 680 will be in an idle state. On the other hand, when the user chooses to connect to the Internet by the RJ-45 network port 680, the slot 780 may be connected instead to an external storage medium, such as a thumb disk, a hard disk, a memory card or the like. In this case, the slot 780 may not only support an SDIO interface or a USB interface standard, but also support such interface standards as a CF card interface, a memory stick interface, a picture card interface, an SM card interface, a microdrive interface, or an MMC interface.

For the apparatus 700, after the user's speech of the remote device 690 transmitted through the microphone undergoes the same AD/DA conversion and encoding procedures as those described above, the encoded speech is transmitted back to the control unit 610 through the second Internet communication apparatus and the Internet in the form of network packets. In response to this, the control unit 610 generates an audio control signal (being set for decoding operation) and also transmits these network packets to the audio codec unit 710 to decode them therein. The decoded audio signal is then transmitted back again to the control unit 610, which further transfers the decoded audio signal through the D/A converter 771 to the loudspeaker 770. At this point, the user of the apparatus 700 will be able to hear speech from his or her counterpart on the remote device 690 side.

Additionally, another distinction from the fifth embodiment is that the sixth embodiment comprises a radio tuner 730 as a receiving unit. The analog audio stream received by the radio tuner 730 is fed into the AD/DA converter 720, and the subsequent processing is just identical to that described in the above process of transmitting the speech from the microphone 760 via the Internet, and therefore will not be described again. In this way, the user of the remote device 690 can listen to programs received by the apparatus 700 (radio tuner 730) no matter wherever he or she is, so long as the remote device 690 has access to the Internet. It should be noted that the radio tuner 730 is an analog tuner, which entails an AD/DA converter 720 to be connected in series with its downstream circuit for AD/DA conversion. Alternatively, in another embodiment of this invention, the radio tuner 730 is a digital tuner. In which case, its downstream circuit need not to be connected in series with an AD/DA converter 720, but is connected directly to the audio codec unit 710.

For the user of the remote device 690, the user can not only listen to programs whatsoever they initially received via the radio tuners 231, 232 passively, but also can choose radio channels actively as desired. This is accomplished by transmitting user settings (including a radio tuning setting) back to the control unit 610 through the second Internet communication programs loaded in the remote devices. Upon receiving the user settings, the control unit 610 operates to change the channels of the radio tuner 730 with the tuning signal according to the users' tuning setting. Even further, the user of the remote device 690 may turn off the radio tuner 730 through the same procedure, in order to conserve power consumption.

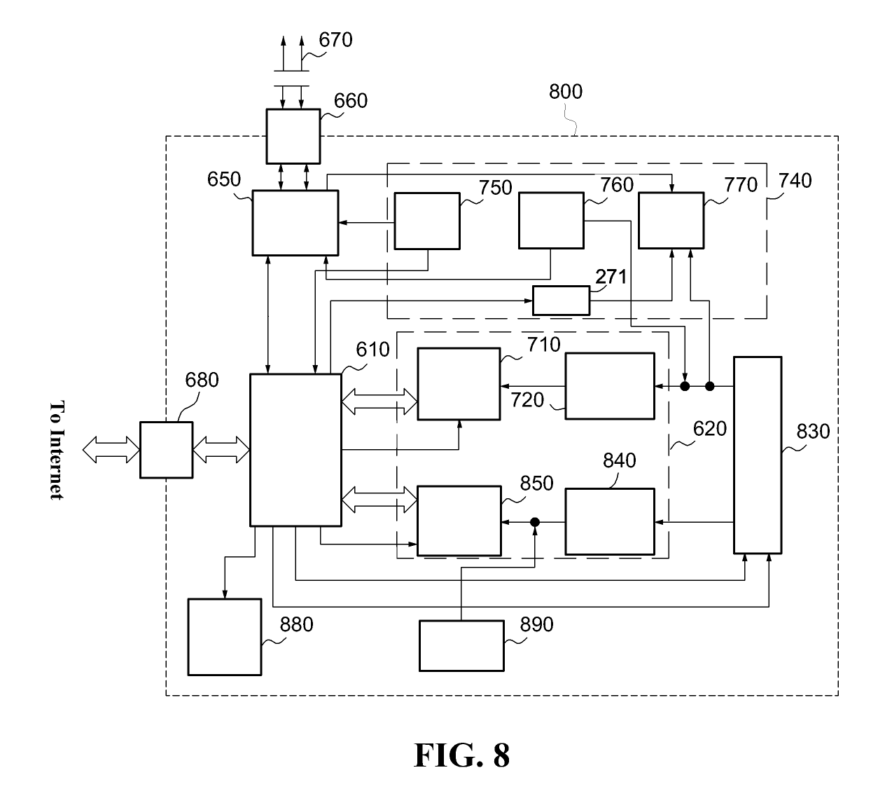

Referring to FIG. 8, a schematic structure of a seventh embodiment of this invention is depicted. A multimedia redirecting and communication apparatus 800 of this invention comprises a control unit 610, a PSTN processing unit 650, an audio codec unit 710, a video codec unit 850, two AD/DA converters 720, 840, a TV tuner 830, a telephone keyboard 750, a microphone 760, a loudspeaker 770, a D/A converter 771, a liquid crystal display (LCD) module 880, an image extraction unit 890, an RJ-45 network port 680, and an RJ-11 port 660.

The seventh embodiment differs from the sixth embodiment in that because a TV tuner 830 is included as a receiving unit and image processing functions are added in the seventh embodiment. For example, since an output of the TV tuner 830 comprises both audio and video streams, an AD/DA converter 840 and a video codec 850 are added in the seventh embodiment to process the video stream inputted by the TV tuner 830. The processing mode is identical to that described above with respect to the audio stream and will not be described again. Thus, network packets outputted from the control unit 610 are multimedia packets comprising both audio and video content. Finally, the remote device 690 decodes these network packets to play programs received by the TV tuners 830. In this way, so long as the remote device 690 has access to the Internet, the user of the remote device 690 can enjoy programs received by the TV tuner 830 no matter wherever he or she is, without missing any live broadcast of favorite ball games. In addition, the user of the remote device 690 can choose TV channels actively as desired, which is accomplished by transmitting user settings (including a TV channel tuning setting) back to the control unit 610 through the second Internet communication programs loaded in the remote devices. Upon receiving the user settings, the control unit 610 operates to change the channels of the TV tuner 730 with the tuning signal according to the users' tuning setting. Even further, the user of the remote device 690 may turn off the TV tuner 830 (by mean of a first switching signal) through the same procedure, in order to conserve power consumption. Alternatively, the TV tuner 830 may be replaced by a satellite receiver.

It should be noted that, in addition to the function to place a network call, the apparatus is further endowed with a function to place a network video call owing to the LCD module (comprising an LCD and an LCD control unit (not shown)) and the image extraction unit 890 added in the seventh embodiment. The audio processing during the process of placing a network video call has been described above in the sixth embodiment, and will not be described again herein. For the video processing, the image extraction unit 890 extracts a user image, which is transmitted to the video codec unit 850 for video encoding and is then transmitted back to the control unit 610. The control unit 610 then combines the encoded video stream and the encoded audio stream into a plurality of network packets, which are then transmitted by the first Internet communication program to the remote device 690 through the Internet. If the remote device 690 is also provided with an LCD module and an image extraction unit, the returned network packets will also comprise encoded video and audio signals. In response to this, the control unit 610 generates an audio control signal and a video control signal (both being set for decoding operation) to facilitate decoding operations of the audio codec unit 710 and the video codec unit 850. The decoded audio stream and video stream are then transmitted back to the control unit 610, which in turn transmits the decoded audio signal to the loudspeaker 770 through the D/A converter 771 and the decoded video signal to the LCD module 880 respectively. At this point, the user of the multimedia redirecting and communication apparatus 800 can both hear the speech and see the image of the user of the remote device 690. Through this process, the control unit 610 may also indicate to the user through the LCD module 880 the current status of the software and hardware in the apparatus 800, the status of the remote device 690, the connection status of the Internet, or the status of communication, for example, Internet connection failure, unanswered call or the like, so that the user may be well informed of the usage message.

It should be noted that, in the fifth, the sixth, and the seventh embodiment of this invention, only a single multimedia stream source is described for purpose of simplicity, e.g., the video/audio source system 630 in the fifth embodiment, the radio tuner 730 in the sixth embodiment, and the TV tuner 830 in the seventh embodiment. However, assume that respective hardware can support each other, a plurality of sources may be equipped to provide a plurality of multimedia streams. In another embodiment, in addition to the TV tuner 830, a video/audio port (e.g., an S terminal or an AV terminal) may also be equipped to receive a multimedia stream from the video/audio source system 630. Or, an additional audio port (such as an analog TRS port or a digital S/PDIF port) may further be equipped to receive a multimedia stream from an audio source system.

In summary, with the PSTN, the Internet and the video/audio source system being interconnected, this invention may not only have the PSTN communication and the Internet communication integrated together, but also allow people to watch (listen) multimedia programs no matter wherever they are. Moreover, since the audio codec units 710, the video codec units 850, and the data transformation unit 620 can all be implemented in software, these advantages can be achieved with a simple hardware structure and a relatively low hardware cost, which renders this invention very suitable for mass production and commercialization.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A television for transmitting a multimedia stream to a remote device, the television being connected to an Internet and comprising:
a data transformation module configured to transform the multimedia stream into a plurality of multimedia packets;
a control unit connected to the data transformation module, being configured to transmit the multimedia packets to the remote device through the Internet;
a television processing unit configured to generate a display signal in response to the multimedia stream it receives; and
a display unit configured to play an image resulting from the multimedia stream in response to the display signal it receives.

2. The television as claimed in claim 1, further comprising:
a public switched telephone network (PSTN) processing unit configured to receive a first communication request signal;
wherein the control unit is further connected to the PSTN processing unit for transmitting a second communication request signal in response to the first communication request signal.

3. The television as claimed in claim 2, further comprising:
a user interface circuit electrically connected to the PSTN processing unit, being configured to transmit the first communication request signal to the PSTN processing unit in response to a user signal.

4. The television as claimed in claim 3, further comprising:
a first telephone line port electrically connected to the user interface circuit and the PSTN processing unit;
wherein the user interface circuit transmits the first communication request signal to the PSTN processing unit through the first telephone line port.

5. The television as claimed in claim 2, wherein the PSTN processing unit is connected to a PSTN, and the television further comprises:
a second telephone line port electrically connected to the PSTN processing unit and the PSTN;
wherein the control unit makes the PSTN processing unit connect to the PSTN via the second telephone line port for transmitting the second communication request signal.

6. The television as claimed in claim 1, wherein the data transformation module comprises at least one set of coding/decoding (codec) devices, and each set comprises:
an audio codec unit connected to the control unit, being configured to decode a plurality of network packets or to encode an audio stream in response to an audio control signal; and
a video codec unit connected to the control unit, being configured to decode the plurality of network packets or to encode a video stream in response to a video control signal;
wherein the network packets are from the Internet.

7. The television as claimed in claim 6, wherein each set of codec devices further comprises:
a first analog-digital/digital-analog (AD/DA) converter connected to the audio codec unit, being configured to convert an analog audio stream into the audio stream for transmitting to the audio codec unit, wherein the audio stream is in a digital format; and
a second AD/DA converter connected to the video codec unit, being configured to convert an analog video stream into the video stream for transmitting to the video codec unit, wherein the video stream is in a digital format.

8. The television as claimed in claim 1, further comprising:
a plurality of television tuners, each of which being configured to receive the multimedia stream, to select a channel from the multimedia stream, so as to generate a demodulated video stream and a demodulated audio stream;
wherein one of the television tuners is configured to transmit the corresponding demodulated video stream and the corresponding demodulated audio stream to the television processing unit, while the rest television tuners are configured to transmit their respective demodulated video streams and respective demodulated audio streams to the data transformation module.

9. The television as claimed in claim 3, wherein the user interface circuit comprises:
an image extraction device configured to extract a user image for transmitting to the data transformation module, so that the data transformation module encodes the user image.

10. The television as claimed in claim 3, wherein the user interface circuit comprises:
a liquid crystal display (LCD) module comprising:
an LCD control unit configured to receive a decoded video signal or a usage message from the control unit; and
an LCD configured to display the decoded video signal or the usage message;
wherein the data transformation module decodes the network packets transmitted from the Internet to derive the decoded video signal.

11. The television as claimed in claim 1, further comprising:
an image extraction device configured to extract a user image for transmitting to the data transformation module, so that the data transformation module encodes the user image.

12. The television as claimed in claim 1, further comprising:
an LCD module comprising:
an LCD control unit configured to receive a decoded video signal or a usage message from the control unit; and
an LCD configured to display the decoded video signal or the usage message;
wherein the data transformation module decodes the network packets transmitted from the Internet to derive the decoded video signal.

13. The television as claimed in claim 2, wherein the PSTN processing unit is connected to a PSTN, and the control unit comprises:
a microprocessor configured to execute a first Internet communication program according to a status of the PSTN, a status of the Internet and a user setting;
a network control circuit connected to the microprocessor and the Internet, being configured to transmit the multimedia packets and to receive the network packets; and
a storage module connected to the microprocessor, being configured to temporarily store the network packets and to access a data.

14. The television as claimed in claim 13, wherein the remote device executes a second Internet communication program, and both the first and the second Internet communication program support an Internet protocol (IP).

15. The television as claimed in claim 8, wherein a user setting of the remote device is transmitted to the control unit through the Internet to control one of the television tuners, and wherein the user setting comprises a switching setting and a tuning setting, and the control unit is further configured to generate a switching signal according to the switching setting and to generate a tuning signal according to the tuning setting.

16. The television as claimed in claim 1, wherein the multimedia stream is received from the Internet, decoded by the data transformation module, and then transmitted to the television processing unit by the control unit.

17. The television as claimed in claim 1, wherein the television processing unit comprises an infrared receiving unit to receive an infrared control signal for selecting the multimedia stream, so as to generate the display signal.

18. A television box for transmitting a multimedia stream to a remote device, the television box being connected to an Internet and comprising:
a data transformation module configured to transform the multimedia stream into a plurality of multimedia packets;
a control unit connected to the data transformation module, being configured to transmit the multimedia packets to the remote device through the Internet; and
a television processing unit configured to generate a display signal in response to the multimedia stream it receives, so that a display unit is able to play an image resulting from the multimedia stream in response to the display signal.

19. The television box as claimed in claim 18, further comprising:
a PSTN processing unit configured to receive a first communication request signal;
wherein the control unit is further connected to the PSTN processing unit for further transmitting a second communication request signal in response to the first communication request signal.

20. The television box as claimed in claim 19, further comprising:
a user interface circuit electrically connected to the PSTN processing unit, being configured to transmit the first communication request signal to the PSTN processing unit in response to a user signal.

21. The television box as claimed in claim 20, further comprising:
a first telephone line port electrically connected to the user interface circuit and the PSTN processing unit;
wherein the user interface circuit transmits the first communication request signal to the PSTN processing unit through the first telephone line port.

22. The television box as claimed in claim 19, wherein the control unit transmits the second communication request signal through the Internet.

23. The television box as claimed in claim 19, wherein the PSTN processing unit is further connected to a PSTN, and the control unit enables the PSTN processing unit to transmit the second communication request signal through the PSTN.

24. The television box as claimed in claim 23, wherein the PSTN processing unit is connected to a PSTN, and the television box further comprises:
a second telephone line port electrically connected to the PSTN processing unit and the PSTN;
wherein the control unit makes the PSTN processing unit connected to the PSTN via the second telephone line port for transmitting the second communication request signal.

25. The television box as claimed in claim 18, wherein the data transformation module comprises at least one set of codec devices, and each set comprises:
an audio codec unit connected to the control unit, being configured to decode a plurality of network packets or to encode an audio stream in response to an audio control signal; and
a video codec unit connected to the control unit, being configured to decode the network packets or to encode a video stream in response to a video control signal;
wherein the plurality of network packets are from the internet.

26. The television box as claimed in claim 25, wherein each set of codec devices further comprises:
a first AD/DA converter connected to the audio codec unit, being configured to convert an analog audio stream into the audio stream for transmitting to the audio codec unit, wherein the audio stream is in a digital format; and
a second AD/DA converter connected to the video codec unit, being configured to convert an analog video stream into the video stream for transmitting to the video codec unit, wherein the video stream is in a digital format.

27. The television box as claimed in claim 18, further comprising:
a plurality of television tuners, each of which being configured to receive the multimedia stream, to select a channel from the multimedia stream it receives, so as to generate a demodulated video stream and a demodulated audio stream;
wherein one of the plurality of television tuners is configured to transmit the corresponding demodulated video stream and the corresponding demodulated audio stream to the television processing unit, while the rest television tuners are configured to transmit their respective demodulated video streams and respective demodulated audio streams to the data transformation module.

28. The television box as claimed in claim 20, wherein the user interface circuit comprises:
an image extraction device configured to extract a user image for transmitting to the data transformation module, so that the data transformation module encodes the user image.

29. The television box as claimed in claim 20, wherein the user interface circuit comprises:
an LCD module comprising:
an LCD control unit configured to receive a decoded video signal or a usage message from the control unit; and
an LCD configured to display the decoded video signal or the usage message;
wherein the data transformation module decodes the network packets transmitted from the Internet to derive the decoded video signal.

30. The television box as claimed in claim 18, further comprising:
an image extraction device configured to extract a user image for transmitting to the data transformation module, so that the data transformation module encodes the user image.

31. The television box as claimed in claim 18, further comprising:
an LCD module comprising:
an LCD control unit configured to receive a decoded video signal or a usage message from the control unit; and
an LCD configured to display the decoded video signal or the usage message;
wherein the data transformation module decodes the network packets transmitted from the Internet to derive the decoded video signal.

32. The television box as claimed in claim 19, wherein the PSTN processing unit is connected to a PSTN, and the control unit comprises:
a microprocessor configured to execute a first Internet communication program according to a status of the public telephone network line, a status of the Internet, and a user setting;
a network control circuit connected to the microprocessor and the Internet, being configured to transmit the multimedia packets and to receive the network packets; and
a storage module connected to the microprocessor, being configured to temporarily store the network packets and to access a data.

33. The television box as claimed in claim 32, wherein the remote device executes a second Internet communication program, and both the first and the second Internet communication programs support an IP.

34. The television box as claimed in claim 27, wherein a user setting of the remote device is transmitted to the control unit through the Internet to control one of the television tuners, and wherein the user setting comprises a switching setting and a tuning setting, and the control unit is further configured to generate a switching signal according to the switching setting and to generate a tuning signal according to the tuning setting.

35. The television box as claimed in claim 18, wherein the multimedia stream is received from the Internet, decoded by the data transformation module, and then transmitted to the television processing unit by the control unit.

36. The television box as claimed in claim 18, wherein the television processing unit comprises an infrared receiving unit to receive an infrared control signal for selecting the multimedia stream, so as to generate the display signal.

37. A multimedia redirecting and communication apparatus for redirecting an input multimedia stream to a remote device and integrating a communication over a public switched telephone network (PSTN) with a communication over an Internet, wherein the multimedia redirecting and communication apparatus comprises:
a control unit configured to execute a first Internet communication program to enable the communication over the Internet, the communication over the PSTN, and redirection of the multimedia stream;
a data transformation module connected to the control unit, being configured to transform the Internet packets and the multimedia stream; and
a PSTN processing unit connected to a PSTN interface and the control unit, being configured to place or receive a call over the PSTN.

38. The multimedia redirecting and communication apparatus as claimed in claim 37, wherein the data transformation module comprises:
an audio codec unit connected to the control unit, being configured to decode a plurality of input network packets or to encode the multimedia stream in response to an audio control signal, wherein the multimedia stream is an audio stream and the audio codec unit is implemented by hardware or software.

39. The multimedia redirecting and communication apparatus as claimed in claim 38, wherein an encoded audio stream encoded by the audio codec unit supports an audio compression standard, the audio stream is in a digital format, and the audio control signal is generated by the control unit.

40. The multimedia redirecting and communication apparatus as claimed in claim 38, wherein the data transformation module further comprises:
a first analog/digital (AD/DA) converter connected to the audio codec unit, wherein when the audio stream is in an analog format, the multimedia stream is first fed into the first AD/DA converter for an AD conversion before being transmitted to the audio codec unit.

41. The multimedia redirecting and communication apparatus as claimed in claim 37, wherein the data transformation module comprises:
a video codec unit connected to the control unit, being configured to decode the plurality of input network packets or to encode the multimedia stream in response to a video control signal, wherein the multimedia stream is a video stream and the video codec unit is implemented by hardware or software.

42. The multimedia redirecting and communication apparatus as claimed in claim 41, wherein the multimedia stream is in a digital format, an encoded video stream encoded by the video codec unit supports a video compression standard, and the video control signal is generated by the control unit.

43. The multimedia redirecting and communication apparatus as claimed in claim 41, wherein the data transformation module further comprises:
a second AD/DA converter connected to the video codec unit, wherein when the video stream is in the analog format, the video stream is first fed into the second AD/DA converter for an AD conversion before being transmitted to the video codec unit.

44. The multimedia redirecting and communication apparatus as claimed in claim 37, further comprising a receiving unit configured to provide the multimedia stream in response to a switching signal and a tuning signal, wherein the control unit is configured to generate the switching signal and the tuning signal according to a user setting.

45. The multimedia redirecting and communication apparatus as claimed in claim 44, wherein the receiving unit is integrated with other components of the multimedia redirecting and communication apparatus.

46. The multimedia redirecting and communication apparatus as claimed in claim 44, wherein the user setting on the remote device is transmitted through a second Internet communication program executed by the remote device, the Internet, and the first Internet communication program to the control unit for controlling the receiving unit, and wherein the user setting comprises a switching setting and a tuning setting, and the control unit is configured to generate the switching signal and the tuning signal of an enabled state according to the user setting.

47. The multimedia redirecting and communication apparatus as claimed in claim 37, further comprising:
a user interface circuit configured to receive/transmit a user message or display a user state, wherein the user interface circuit comprises an input unit and an output unit connected to the PSTN processing unit and the control unit.

48. The multimedia redirecting and communication apparatus as claimed in claim 47, wherein the input unit of the user interface circuit comprises:
a keyboard connected to the PSTN processing unit and the control unit; and
a microphone, an output of which is connected to the data transformation module through a third AD/DA converter, and is connected to the PSTN processing unit.

49. The multimedia redirecting and communication apparatus as claimed in claim 48, wherein the input unit of the user interface circuit further comprises:
an image extraction device configured to extract a user image for transmitting to the video codec unit, so that the video codec unit encodes the user image.

50. The multimedia redirecting and communication apparatus as claimed in claim 47, wherein the output unit of the user interface circuit comprises:
a loudspeaker configured to receive through a digital/analog (D/A) converter a decoded audio signal transmitted by the control unit, wherein the audio codec unit decodes the network packets transmitted from the Internet to derive the decoded audio signal.

51. The multimedia redirecting and communication apparatus as claimed in claim 50, wherein the output unit of the user interface circuit further comprises:
a liquid crystal display (LCD) module comprising an LCD and an LCD control unit, being configured to receive a decoded video signal or a usage message transmitted from the control unit to display an image or the usage message;
wherein the video codec unit decodes the network packets transmitted from the Internet to derive the decoded video signal.

52. The multimedia redirecting and communication apparatus as claimed in claim 37, wherein the control unit comprises:
a microprocessor configured to execute the first Internet communication program according to a status of the PSTN, a status of the Internet and a user setting;
a network control circuit connected to the microprocessor and the Internet, being configured to control transmission and reception of the plurality of network packets; and
a storage module connected to the microprocessor, being configured to allow for data access and temporary storage of the plurality of network packets.
